(19) United States
(12) Patent Application Publication
(10) Pub. No.: US 2017/0194994 A1
(43) Pub. Date: Jul. 6, 2017

(54) Hands Free Mobile Wristlet System

(71) Applicant: Ebony Blackmon-Humphrey, Rochester Hills, MI (US)

(72) Inventor: Ebony Blackmon-Humphrey, Rochester Hills, MI (US)

(21) Appl. No.: 14/986,314

(22) Filed: Dec. 31, 2015

(51) Int. Cl. H04B 1/3827; H04M 1/04

(52) U.S. Cl. CPC H04B 1/385; H04M 1/04; H04B 2001/3861

(57) ABSTRACT

The present invention discloses a removable device carrier system attached to the wrist to hold and present the viewing of articles such as cell phones, mobile devices, etc. The user slips on an elastin member worn over part of the hand. Next the user engages an elastin coupling member over the elastin member of the hand. This carrier has a telescoping member adjustable to a height of 4 to 6 inches from the base of a coupling member. The bottom portion of the telescoping member is fixed to the elastin coupling member and the top portion of the telescoping member is disengageable to the article carrier receptacle which itself swivels and rotates 360 degrees with the capability to pivot on a horizontal and vertical axis.

### FIELD OF THE INVENTION

This invention relates to a hands free removable device carrier system. A wristlet coupler is attached to the wrist to hold and present the viewing of articles such as cell phones, mobile devices, etc. Moreover, the removable device system contains additional component members for holding and viewing the holder portion of the wristlet apart from the wristlet itself.

### BACKGROUND OF THE INVENTION

Currently there exists a variety of phone holders that are available for the purpose of just holding the phone either on the wrist or on the upper arm. The holders have a pouch and the phone or article that is held inside. The available holders either have a wrap around band or a case for housing the handheld device. There is no other use for these available holders.

With the current device holders on the market once there is a need for using the phone, article, or hand held device, it must be taken out of the pouch or removed from the holder and used while in hand. There is no way to be able to do anything else with the holder and both hands are involved in dialing, holding, and operating the handheld device, thus, rendering both hands occupied. Furthermore, handheld device users hold the device in hand due to the fact that if needed to be used frequently, it must be taken off the available holders and must be held in palms of user hands.

The inventor's hands free mobile wristlet system empowers users to view and interact with device content from the wrist. The device is useful in allowing parents of minor children to watch content from their mobile device without the need to prop the device or allow the child to handle the device without supervision. The device will reduce fatigue associated with grabbing and holding of devices and provides the ability to share visual screens with others.

An aspect of the invention is to aid the disabled who are unable to grasp a mobile device because of flaccidity. The device gives them the ability to watch content displayed from their mobile device and engage in video conferencing calls.

### SUMMARY

The present invention is directed to Hands Free Mobile Wristlet System that requires elastin, and mesh with a front enclosure (snaps and/or buttons). It requires an adjustable flexible telescoping member that can be raised at a length of between 2 to 6 inches from above its wristlet base. The invention has a mesh elastin member fitting over the hand allowing the index and middle finger to securely slide in on the underhand side, a weight bearing wrist band to support the weight of the apparatus and device, a weight bearing wrist band bracket, an article carrier receptacle, a flexible telescoping member, and a gooseneck docking base member which can hold and view the article carrier device and device wherein apart from the wristlet.

The article carrier receptacle 360° swiveling bracket will have the ability to rotate 360 degrees with the capability to pivot on a horizontal and vertical axis, any commercial available means today for permanently attaching the said article carrier receptacle 360° swiveling bracket to the said flexible telescoping member that allows both the engagement and disengagement article carrier receptacle.

This invention allows the user to hold his/her device to enable the user or others to view the screen for an extended period of time. When one has to hold the device with both or one hand it reduces ones' your ability to multitask. The device allows for both hands to be free, so that multiple viewers can access the screen without having to hold the phone while others watch your screen.

### BRIEF DESCRIPTION OF THE DRAWING FIGURES

FIG. 1 is a perspective view of one embodiment of the present invention;

FIG. 2 is a perspective view of one embodiment of the present invention illustrating how the article carrier receptacle 360° swiveling bracket engages into the swiveling bracket engagement and disengagement attachment member and how the flexible telescoping member engages into the weight bearing wrist band bracket;

FIG. 3 is a perspective view of one embodiment of the present invention;

FIG. 4 is a perspective view of one embodiment of the present invention where the base clip attached to gooseneck docking base member can dock to a separate article;

FIG. 5 is a perspective view of one embodiment of the present invention illustrating the palm view of the mesh elastin member;

FIG. 6 is a perspective view of one embodiment of the present invention illustrating that the vehicle head rest docking base engages with the article carrier receptacle;

### REFERENCE LISTING OF THE NUMBERED ELEMENTS

100 mesh elastin member
200 weight bearing wrist band
300 weight bearing wrist band bracket
400 outer surface area of the weight bearing wrist band
500 article carrier receptacle
550 article carrier receptacle 360° swiveling bracket
600 flexible telescoping member
700 gooseneck docking base member
800 hand held device
900 finger openings
910 an electronic display article
920 an article carrier receptacle 360° swiveling bracket
930 porous framework
940 swiveling bracket engagement and disengagement attachment member
950 base clip
960 vehicle head rest docking base

### Definitions

In the following description, the term “hands free mobile wristlet system” as used herein means all components of the invention system including the gooseneck docking base member.

In the following description, the term “mesh elastin member” as used herein, is a mesh of elastin worn over the hand in which there are two finger openings on the palm side of the hand for the middle and ring finger to be secured into.

In the following description, the term “weight bearing wrist band” as used herein, is a wristband-coupling member which is an integral part of the mesh elastin which secures and fastens the weight bearing wrist band and mesh elastin on the wrist and supports the weight of the weight bearing wrist brand, weight bearing wrist band bracket, the flexible telescoping member, the article carrier receptacle, and the article held within the article carrier receptacle.

In the following description, the term “weight bearing wrist band bracket” as used herein refers to a bracket affixed and fastened upon the weight bearing wrist band which engages with the telescoping member.

In the following description, the term “outer surface area of the weight bearing wrist band” as used herein refers to the outside surface area of the weight bearing wrist band.

In the following description, the term “article carrier receptacle” as used herein refers a article carrier receptacle that will both engage and disengage with article carrier receptacle 360° swiveling bracket and which will hold the article to be viewed within the Hands Free Mobile Wristlet System.

In the following description, the term “flexible telescoping member” as used herein refers to a telescoping member that is permanently fixed to one end of the weight bearing wrist band bracket and is permanently affixed and fastened at the opposite end to the article carrier receptacle 360° swiveling bracket and is flexible with sufficient strength to hold the article carrier receptacle 360° swiveling bracket, the article carrier receptacle, and the article therewith held in the article carrier receptacle. The flexible telescoping member also adjustably and variably extends and retracts from two inches to six inches.

In the following description, the term “article carrier receptacle 360° swiveling bracket” has used herein is a article carrier receptacle that is permanently attached to the flexible telescoping member and affixes to the article carrier receptacle and allows the disengagement of the article carrier receptacle from the from the article carrier receptacle 360° swiveling bracket.

In the following description, the term “gooseneck docking base member” has used herein refers to a gooseneck docking base member that holds the article carrier receptacle once the article carrier receptacle is disengaged from the article carrier receptacle 360° swiveling bracket.

In the following description, the term “elastin mesh” has used herein refers to a material that has the capability to resume its shape after stretching or contracting and providing ventilation through its porous framework.

As used herein, “fasteners” means any customary means to fasten one object to another, including threaded fasteners, non-threaded fasteners, staples, tape, adhesives, welding, or other means as will be appreciated by those having skill in the art and benefit of this disclosure whether for permanent or semi-permanent use. Unless otherwise explained, any technical terms used herein have the same meaning as commonly understood by one of ordinary skill in the art to which this disclosure belongs.

The singular terms “a”, “an”, and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” All publications, patent applications, patents, and other references listed in this disclosure are incorporated by reference in their entirety for all purposes. In case of conflict, the present specification, including explanations of terms, will control. In addition, the materials, methods, and examples are illustrative only and not intended to be limiting.

### BRIEF DESCRIPTION OF THE DRAWINGS

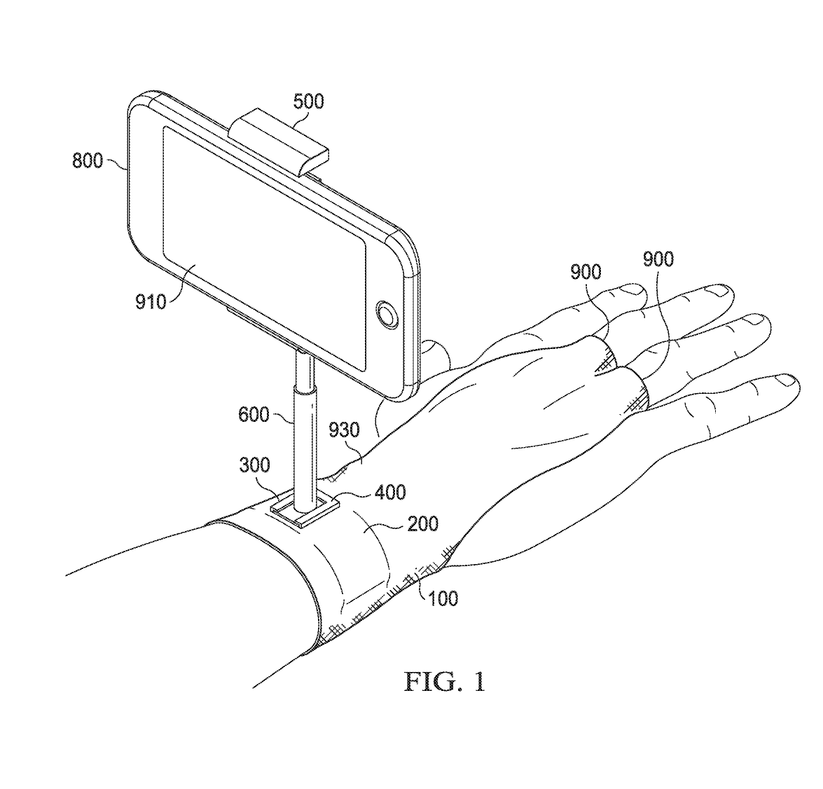

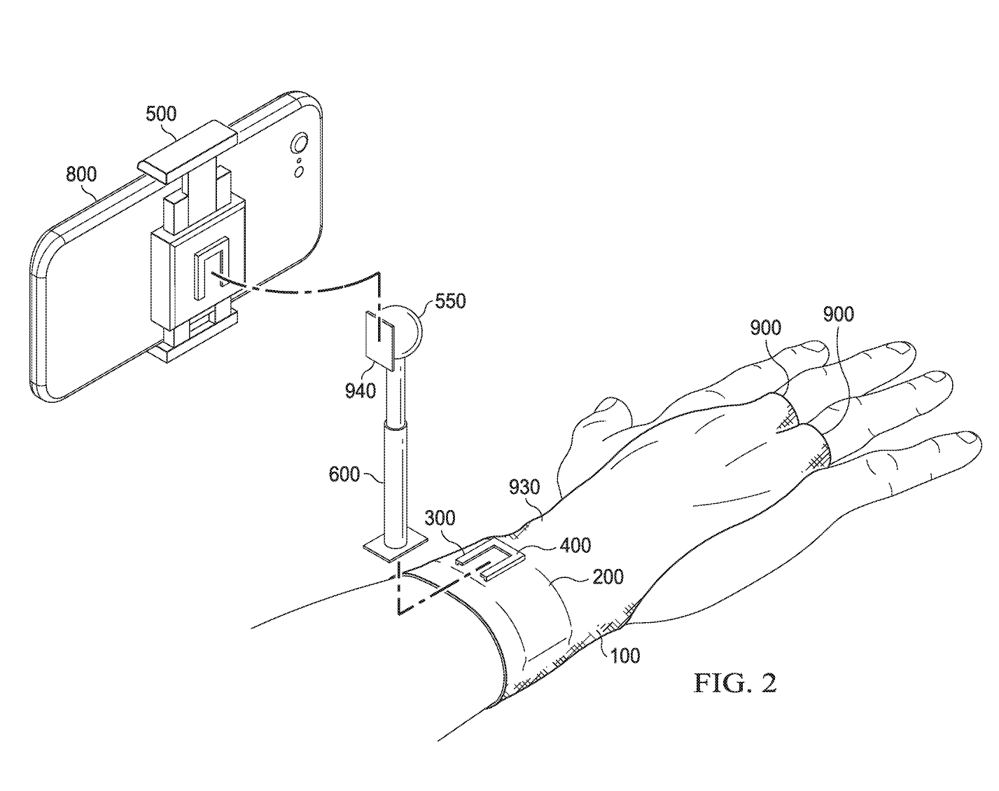

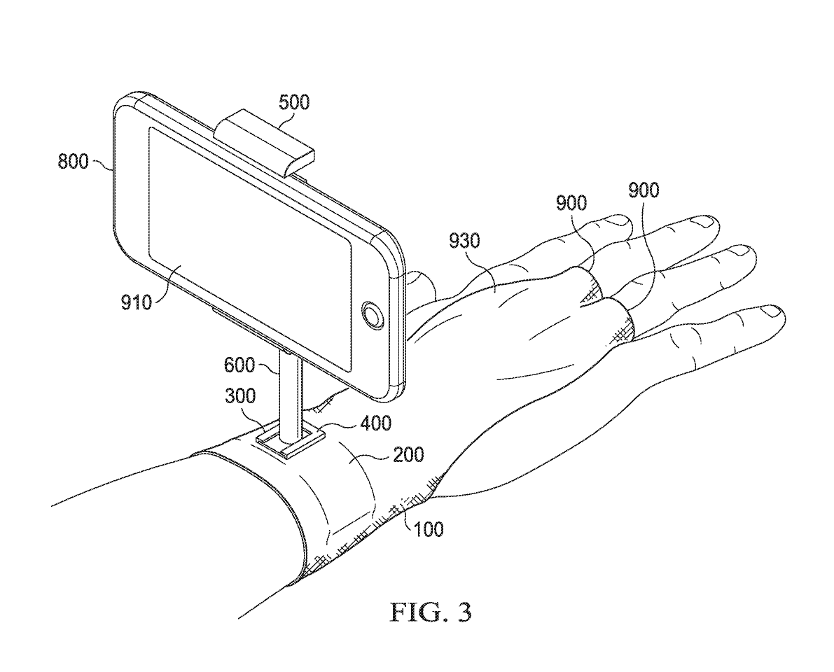

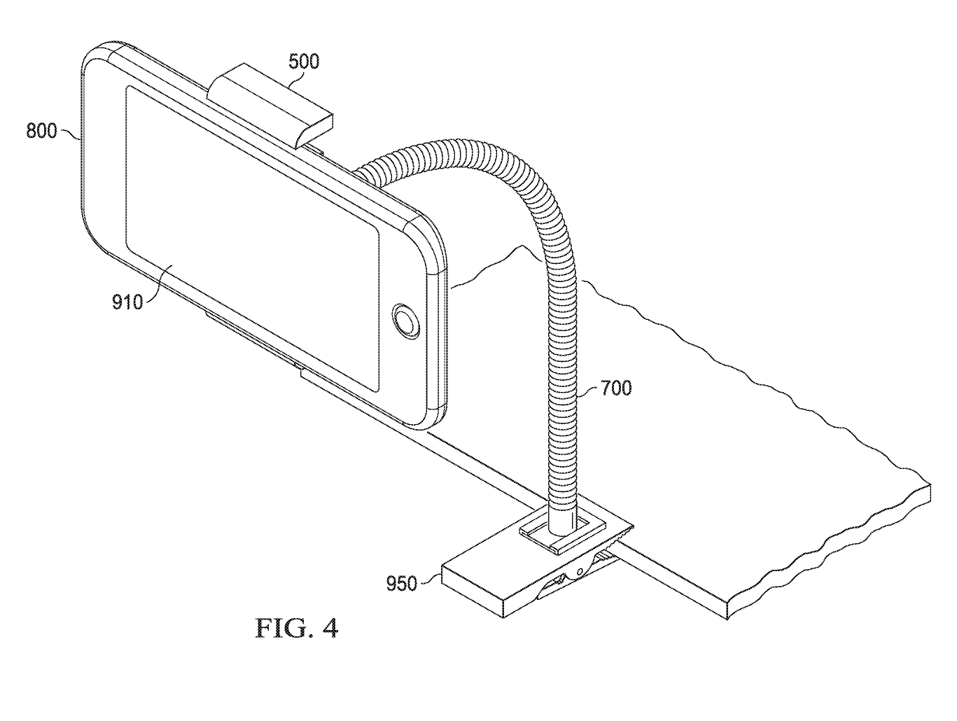

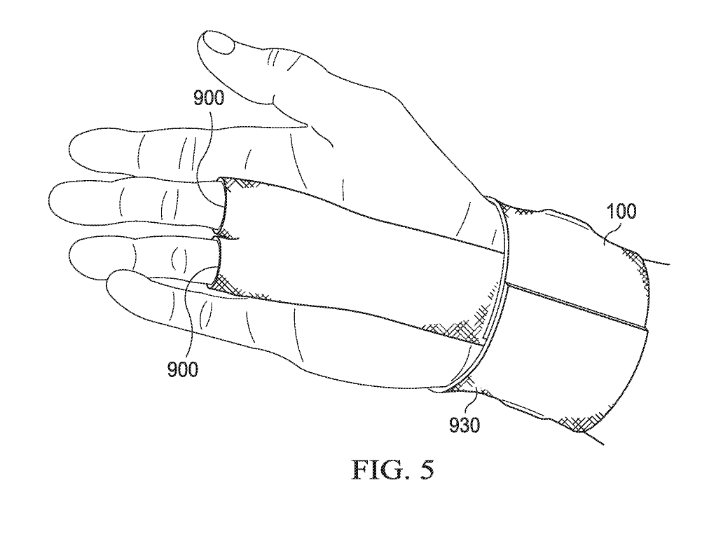

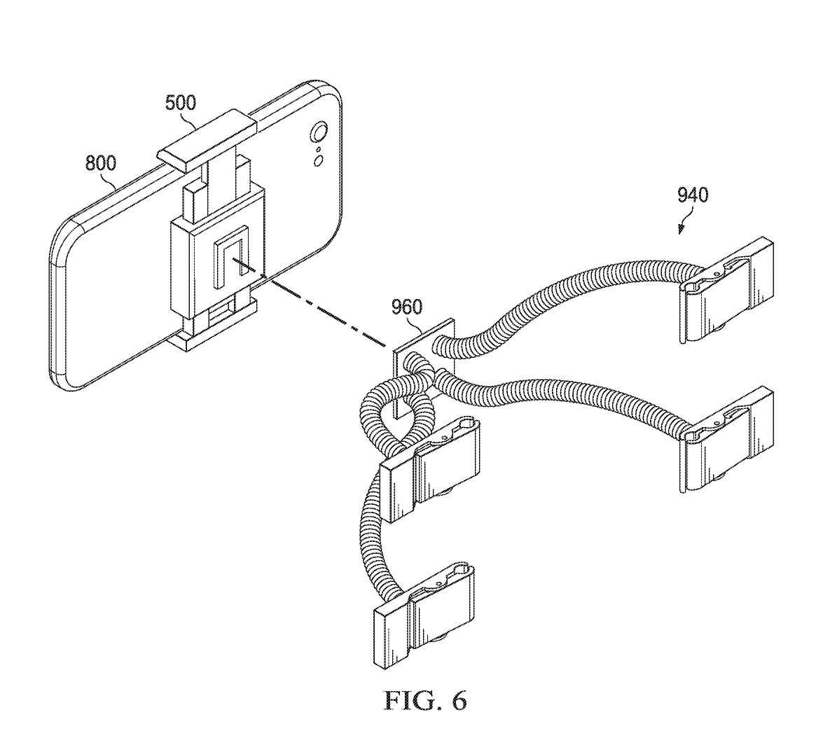

Referring generally to FIGS. 1-6, embodiments according to the present invention for hands free mobile wristlet system the mesh elastin member 100 will provide support by fitting over the hand and the middle and ring finger sliding in the underside of the mesh elastin member. The weight bearing wrist band 200 will support the weight of the entire apparatus and the device article being held in the article carrier receptacle 500. The weight bearing wrist band bracket 300 will attach to the outer surface area 400 of the weight bearing wrist band 200. One end of the extendable and retractable flexible telescoping member 600 will permanently attach to the weight bearing wrist band bracket 300. The other end of the extendable and retractable flexible telescoping member 600 will permanently attach to the article carrier receptacle 360° swiveling bracket 550. The article carrier receptacle 360° swiveling bracket 550 will allow for the capability to pivot on a horizontal and vertical axis and also swivel 360°.

The article carrier receptacle 500 will be engageable and dis-engageable in the article carrier receptacle bracket 550. The article carrier receptacle 500 will be dis-engageable from the article carrier receptacle 360° swiveling bracket 550. After the article carrier receptacle 500 is disengaged from the article carrier receptacle 360° swiveling bracket 550, the article carrier receptacle can be engaged on to the externally separately placed gooseneck docking base member 700. Further, after the article carrier receptacle 500 is disengaged from the article carrier receptacle 360° swiveling bracket 550, it can be engaged on to the externally separate vehicle head rest docking base 960.

It should be understood that the drawings and detailed description herein are to be regarded in an illustrative rather than a restrictive manner, and are not intended to be limiting to the particular forms and examples disclosed. Accordingly, it is intended that this disclosure encompass any further modifications, changes, rearrangements, substitutions, alternatives, design choices, and embodiments as would be appreciated by those of ordinary skill in the art having benefit of this disclosure, and falling within the scope of the following claims.

What is claimed is:

1. A apparatus for holding electronic display articles on the wrist and the article therewith, comprising in combination:
a mesh elastin member worn over the front of the hand and the palm of the hand with finger openings for the middle and ring finger to be inserted into, the said mesh elastin member having a porous framework to provide hand to air ventilation, a weight bearing wrist band integrated by being sewn into said mesh elastin member, a weight bearing wrist band bracket permanently attached to the outer surface of the weight bearing wrist band, a flexible telescoping member with variable extension between two and six inches in length configured to extend above the weight bearing wrist band, an article carrier receptacle for securely holding electronic display articles, an article carrier receptacle 360° swiveling bracket fastened to the article carrier receptacle configured to rotate 360° degrees and having a means for pivoting on a horizontal and vertical plane, a swiveling bracket engagement and disengagement attachment member to attach the said article carrier receptacle 360° swiveling bracket to the said flexible telescoping member that allows both the engagement and disengagement of the article carrier receptacle.

2. The apparatus according to claim 1 further comprising a separate gooseneck docking base member that holds the said article carrier receptacle and the article contained therein in a separate location from the weight bearing wrist band bracket.

3. A method for holding electronic display articles on the wrist, comprising the steps of:
1) providing a mesh elastin member worn over the front of the hand and the palm of the hand with finger openings for the middle and ring finger to be inserted into, the said mesh elastin member having a porous framework to provide hand to air ventilation, a weight bearing wrist band integrated by being sewn into said mesh elastin member, a weight bearing wrist band bracket permanently attached to the outer surface of the weight bearing wrist band, a flexible telescoping member with variable extension between two and six inches in length configured to extend above the weight bearing wrist band, an article carrier receptacle for securely holding electronic display articles, an article carrier receptacle 360° swiveling bracket fastened to the article carrier receptacle configured to rotate 360° degrees and having a means for pivoting on a horizontal and vertical, swiveling bracket engagement and disengagement attachment member to attach the said article carrier receptacle 360° swiveling bracket to the said flexible telescoping member that allows both the engagement and disengagement of the article carrier receptacle;
2) Slide the middle and ring finger in the finger openings of the elastin member;
3) Place the electronic display article into the article carrier receptacle;
4) Swivel and manipulate the article carrier receptacle to the desired position for optimal viewing;
5) Once the need to view the electronic display article has ended remove the electronic display article from the article carrier receptacle.

4. A method for holding electronic display articles on the wrist, comprising the steps of:
1) providing a mesh elastin member worn over the front of the hand and the palm of the hand with finger openings for the middle and ring finger to be inserted into, the said mesh elastin member having a porous framework to provide hand to air ventilation, a weight bearing wrist band integrated by being sewn into said mesh elastin member, a weight bearing wrist band bracket permanently attached to the outer surface of the weight bearing wrist band, a flexible telescoping member with variable extension between two and six inches in length configured to extend above the weight bearing wrist band, an article carrier receptacle for securely holding electronic display articles, an article carrier receptacle 360° swiveling bracket fastened to the article carrier receptacle configured to rotate 360° degrees and having a means for pivoting on a horizontal and vertical, a swiveling bracket engagement and disengagement attachment member to attach the said article carrier receptacle 360° swiveling bracket to the said flexible telescoping member that allows both the engagement and disengagement of the article carrier receptacle;
2) Slide the middle and ring finger in the finger openings of the elastin member;
3) Place the electronic display article into the article carrier receptacle;
4) Swivel and manipulate the article carrier receptacle to the desired position for optimal viewing;
5) Once the need to view the electronic display article on the wrist has ended engage the article carrier receptacle containing the electronic display article on to the gooseneck docking base member to be attached by clipping to a desired location capable of being clipped on to or alternatively engaging the article carrier receptacle containing the electronic display article on to the vehicle head rest docking base and connect the vehicle head rest docking base onto the head rest of the desired vehicle adjusting the article carrier receptacle containing the electronic display article for desired viewing of the electronic display article.
